(19) United States
(12) Patent Application Publication
(10) Pub. No.: US 2012/0144979 A1
(43) Pub. Date: Jun. 14, 2012

(54) FREE-SPACE GESTURE MUSICAL INSTRUMENT DIGITAL INTERFACE (MIDI) CONTROLLER

(75) Inventor: Dennis Stewart William Tansley, Issaquah, WA (US)

(73) Assignee: MICROSOFT CORPORATION, Redmond, WA (US)

(21) Appl. No.: 12/963,866

(22) Filed: Dec. 9, 2010

(51) Int. Cl. G10H 7/00

(52) U.S. Cl. 84/645

(57) ABSTRACT

The free-space gesture MIDI controller technique described herein marries the technologies embodied in a free-space gesture controller with MIDI controller technology, allowing a user to control an infinite variety of electronic musical instruments through body gesture and pose. One embodiment of the free-space gesture MIDI controller technique described herein uses a human body gesture recognition capability of a free-space gesture control system and translates human gestures into musical actions. Rather than directly connecting a specific musical instrument to the free-space gesture controller, the technique generalizes its capability and instead outputs standard MIDI signals, thereby allowing the free-space gesture control system to control any MIDI-capable instrument.

### BACKGROUND

The creativity of musicians is enhanced through new musical instruments. Low-cost mass-market computing has brought an explosion of new musical creativity through electronic and computerized instruments. The human-computer interface with such instruments is key. The widely accepted Musical Instrument Digital Interface (MIDI) standard provides a common way for various electronic instruments to be controlled by a variety of human interfaces.

MIDI is a standard protocol that allows electronic musical instruments, computers and other electronic devices to communicate and synchronize with each other. MIDI does not transmit an audio signal. Instead it sends event messages about pitch and intensity, control signals for parameters such as volume, vibrato and panning, and clock signals in order to set a tempo. MIDI is an electronic protocol that has been recognized as a standard in the music industry since the 1980s.

All MIDI compatible controllers, musical instruments and MIDI compatible software follow the standard MIDI specification and interpret any MIDI message in the same way. If a note is played on a MIDI controller, it will sound the right pitch on any MIDI-capable instrument.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The free-space gesture MIDI controller technique described herein marries the technologies embodied in a free-space gesture controller with MIDI controller technology, allowing one or more users to control an infinite variety of electronic musical instruments through body gesture and pose.

The technique provides a means for a free-space gesture controller connected to a computing device (for example, a game console) to output standard MIDI control signals. In general, in one embodiment of the technique, this is done through a MIDI hardware interface between signals of the computing device and the MIDI-capable instrument or instruments. Alternately, a MIDI hardware interface between the free-space gesture controller device and a MIDI-capable instrument can be employed, if the free-space gesture controller has enough computing power to compute the necessary computations to convert the gestures to MIDI control signals. A mapping between user gestures and MIDI control elements (e.g., a map of a particular limb gesture to a particular MIDI control parameter) is used to convert captured user gestures into MIDI control commands. These MIDI control commands are then sent to any MIDI-capable instrument or device in order to play or operate the instrument or device.

More particularly, in one embodiment, the technique uses free-space gesture recognition to control a MIDI-capable electronic musical instrument as follows. Free-space gestures of one or more human beings simulating playing an electronic musical instrument are captured and recorded. Each free-space gesture of each human being is converted to a standard MIDI control signal for a standard MIDI-capable musical instrument using a predetermined mapping of user gestures to MIDI control signals representing specific notes, a chord, a sequence or transport control of a music sample. The mapped MIDI control signals are then used to play the one or more standard MIDI-capable musical instruments.

### DESCRIPTION OF THE DRAWINGS

The specific features, aspects, and advantages of the disclosure will become better understood with regard to the following description, appended claims, and accompanying drawings where:

FIG. 1 depicts a schematic of an exemplary architecture for employing one embodiment of the free-space gesture MIDI controller technique.

FIG. 2 depicts a flow diagram of an exemplary process for practicing one embodiment of the free-space gesture MIDI controller.

FIG. 3 depicts a flow diagram of another exemplary process for practicing another embodiment of the free-space gesture MIDI controller technique.

FIG. 4 is a schematic of an exemplary computing device which can be used to practice the free-space gesture MIDI controller technique.

### DETAILED DESCRIPTION

In the following description of the free-space gesture MIDI controller technique, reference is made to the accompanying drawings, which form a part thereof, and which show by way of illustration examples by which the free-space gesture MIDI controller technique described herein may be practiced. It is to be understood that other embodiments may be utilized and structural changes may be made without departing from the scope of the claimed subject matter.

1.0 Free-Space Gesture MIDI Controller Technique

The following sections provide background information, an overview of the free-space gesture MIDI controller technique, as well as an exemplary architecture and exemplary processes for practicing the technique.

1.1 Background

It is nearly pervasive practice for electronic musical instruments to be controlled using the MIDI standard protocol which allows separation of the sound-generating engine from the device that the human player uses to control that engine. The most common device used by humans to control sound generation over MIDI today is the electronic piano-style keyboard. This comes in a variety of established sizes, but all are “piano-like” in general style and appearance. Less common controllers include a guitar-style controller (usually a normal guitar augmented with additional components to convert conventional player actions into MIDI signals), and a breath controller (which similarly uses conventional player actions of instruments such as a clarinet or saxophone, but in this case, typically does not use the conventional instrument as a base but instead uses a purpose-built device that outputs MIDI signals and only superficially is fashioned after a conventional instrument). A variety of other unique MIDI controllers exist, including one-off examples such as a laser harp.

1.2 Overview of the Technique

One embodiment of the free-space gesture MIDI controller technique described herein uses a human body gesture recognition capability of a free-space gesture controller or control system (such as, for example, Microsoft® Corporation's Kinect™ controller that is typically used as a controller for a gaming system) and translates human gestures into musical actions. Rather than directly connecting a specific musical instrument to the free-space gesture controller, the technique generalizes its capability and instead outputs standard MIDI signals, thereby allowing the free-space gesture control system to control any MIDI-capable instrument. For purposes of this disclosure, a MIDI-capable instrument can be any device that can understand MIDI-commands.

One such free-space gesture controller or control system that can be employed with the technique has a depth camera that helps to interpret a scene playing out in front of it. Together with software running on a computing device (e.g., such as, for example, a gaming console such as, for example, Microsoft® Corporation's Xbox 360®), the free-space gesture control system can interpret the scene captured by the depth camera to determine and recognize specific gestures being made by the human in front of the device. These gestures can be mapped to specific meanings to corresponding notes, chords, sequences, transport controls, and the like.

In one embodiment of the technique, either a human must specify the mapping a priori, or at least be aware that a mapping exists. The mapping is usually preferably consistent—i.e., the same gesture performed at different times results in the same meaning. The gesture meanings could include such acts as playing a specific note, a chord, a sequence, or transport control of a music sample. Note that it is common today for musicians to not play notes one by one, or chord by chord, but through the creative control of a sample of pre-existing music often called a “loop”. Some users may want specific editorial control over the mapping and one embodiment of the technique allows editing of the mapping of the gestures to the corresponding notes, chords, sequences, and transport controls.

In one embodiment of the technique in order to generate the MIDI signals from the free-space gesture control system, or from a free-space gesture controller and associated computing device, a standard physical MIDI interface is employed (e.g., DIN socket for MIDI OUT). A MIDI interface box is plugged into an existing free-space gesture controller or free-space gesture controller/computing device combination, from which the MIDI signals emerge. Thus, free-space gesture control system signals are converted to MIDI control signals.

The free-space gesture controller system used standalone, or free-space gesture control system/computing device combination, converts captured gestures to free-space gesture control signals, and then those free-space gesture control signals are mapped to the MIDI signals/electronics using the free-space gesture MIDI control technique. In one embodiment, MIDI signals are output over a USB interface. This then allows standard USB-MIDI hardware to be used, which is widely available.

In one embodiment of the technique, the mapping of gestures to MIDI signals can either be fixed, or can be editable by the end user to allocate certain gestures to certain control meanings.

There are various variations to the embodiments discussed above. For example, since some free-space gesture control systems have the ability to record sound. One embodiment of the technique uses this recorded sound it to supplement the control signals with audio signals. For example, audio of a user who is singing, or playing a conventional acoustic instrument (or both) is captured and mixed with real instrument control. Additionally, another embodiment of the technique allows for the attachment of a hand-held microphone or other auxiliary microphones to better capture this supplemental audio signal.

In another embodiment of the free-space gesture MIDI control technique, local multi-party playing of electronic instruments is supported. For example, some free-space gesture controllers have the capability to capture gestures from multiple humans in a room. This functionality can be employed by the technique to allow multiple players to each play an instrument, or to allow multiple players to play the same single instrument (e.g., a keyboard for example).

In one embodiment of the technique, remote multi-party playing of electronic instruments is supported. For example, some free-space gesture controllers have real-time remote communications capability. One embodiment of the technique uses this capability to allow remote players to combine their gesturing to create music over distance via a network in a new shared social experience.

1.3 Exemplary Architecture

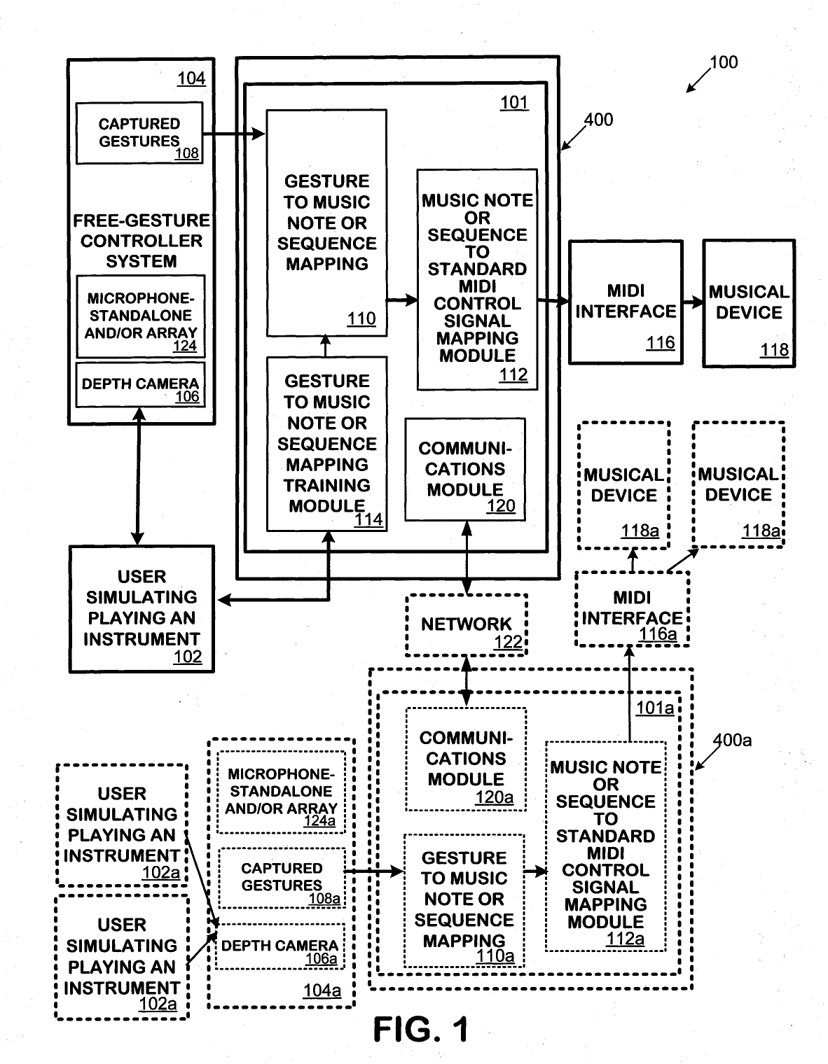

FIG. 1 depicts an exemplary architecture 100 for employing one embodiment of the free-space gesture MIDI controller technique described herein.

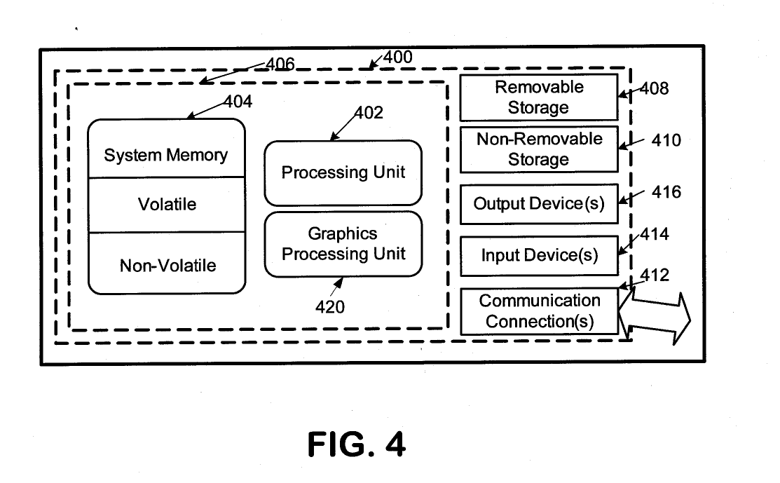

As shown in FIG. 1, gestures of a user 102 simulating playing a musical instrument are captured using a free-space gesture control system 104 which employs a depth camera 106. In one embodiment of the technique, a gesture capturing module 108 of the free-space gesture control system 104 captures and interprets gestures of the user with the depth camera 106 by transmitting encoded information on infrared light patterns in a space where the human being 102 is gesturing and then capturing changes to the encoded infrared light patterns with the depth camera 106 to determine which gestures the human being 102 is making. The captured gestures are sent to a free-space gesture to MIDI mapping module 101 that resides on a computing device 400 which will be explained in greater detail with respect to FIG. 4.

In one embodiment, in order to determine a mapping 110 between gestures captured and standard control signal for making a given musical note, chord, sequence, transport control, and the like, a training module 114 is employed. More specifically, each gesture captured is mapped to a standard control signal for operating a musical device so as to associate certain gestures with a standard control signal to make a musical sequence or note. In one embodiment, the training module 114 prompts a human being 102 to make a gesture representing a musical note or sequence. The gesture made by the prompted human being is then recorded and associated with a corresponding control signal for making that particular musical note or sequence.

Once the mapping 110 has been created, each gesture by the user simulating playing an instrument 102 is mapped to the standard control signal (e.g., a MIDI control signal) for operating an electronic musical device to create the corresponding notes, sequences, and so forth. The mapping 110 is used to translate each captured gesture 108 into a standard MIDI control signal in a MIDI mapping module 112. These standard MIDI control signals are output to a standard MIDI hardware interface 116 that sends the signal to any MIDI-capable musical instrument 118 (or other MIDI-capable device) that creates the sounds (or executes commands) that correspond to the users' gesturing.

In one embodiment of the technique, the computing device 400 which converts the gestures to MIDI signals can also be equipped with a communications module 120 which communicates with at least one other computing device 400a over a network 122. This at least one other computing device 400a is also equipped with a free-space gesture control system 104a and a gesture mapping catalog 110a and a MIDI control signal mapping module 112a. One or more users 102a, 102b can create gestures simulating the playing of the same or different instruments which are recorded using the free-space gesture control system 108a and converted to MIDI control signals using the gesture mapping catalog 110a and the MIDI control signal mapping module 112a. These standard MIDI control signals are output to a standard MIDI hardware interface 116a that sends the signal to MIDI-capable musical instrument 118a, 118b that create the sounds that correspond to the users' 102a, 102b gesturing. These control signals can also be sent to the free-space gesture MIDI controller 100 over the network 118 and be simultaneously played at the location of the free-space gesture controller.

It should be noted that the free-space gesture controller system 104 can also include one or more microphones 122 to capture audio at the location of the user 102 simulating playing an instrument. In fact, in one embodiment a microphone array is used to assist in providing sound source localization and therefore the location of the user (or users if there is more than one).

An exemplary architecture for practicing the technique having been described, the next section discusses some exemplary processes for practicing the technique.

1.4 Exemplary Processes for Employing the Free-Space Gesture MIDI Controller Technique

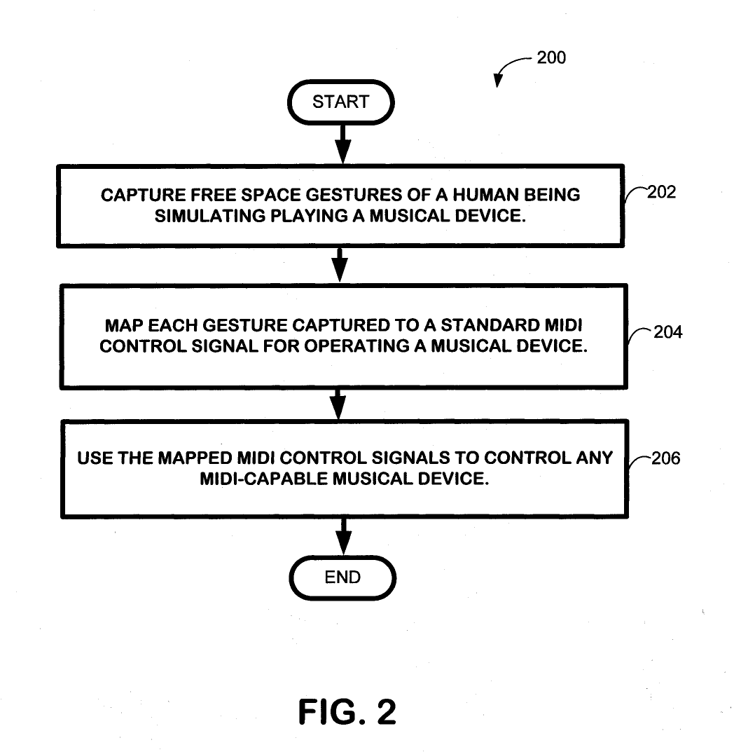

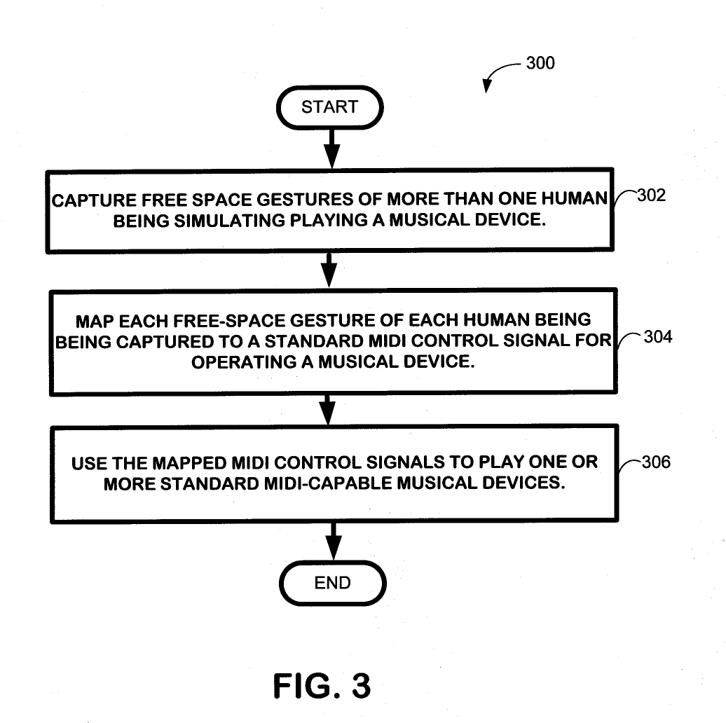

FIGS. 2 and 3 and the following paragraphs provide descriptions of exemplary processes 200, 300 for practicing the free-space gesture MIDI controller technique described herein. It should be understood that in some cases the order of actions can be interchanged, and in some cases some of the actions may even be omitted.

FIG. 2 provides a flow diagram of an exemplary process 200 for using free-space gesture recognition to control a MIDI-capable musical device, such as for example a musical instrument, synthesizer, and so forth, according to one embodiment of the technique. As shown in block 202, free-space gestures of a human being (user) simulating playing a musical device are captured. For example, the gesture can be captured using a depth camera in a free-space gesture controller. Additionally, the audio of the user (vocal or audio from another instrument) and any additional human beings present can also be captured. For instance, this may occur when the user is vocalizing or playing (even simultaneously) an acoustic or another electronic instrument in the same room. Additionally, the audio can be captured by a microphone array that can also perform sound source localization.

Each gesture captured is mapped to a standard MIDI control signal for operating the electronic device, as shown in block 204. For example, each gesture captured can be mapped to a standard MIDI control signal using a game console or other computing device. In one embodiment of the technique the mapping of each gesture to a standard MIDI control signal is fixed based on a pre-set gesture ontology. In an alternate embodiment, the mapping of each gesture to a standard MIDI control signal is editable by a user to allocate certain gestures to certain control signal meanings.

The mapped MIDI control signals are used to control a MIDI-capable electronic device, as shown in block 206. It should be noted that any MIDI-capable electronic device can be controlled with the mapped gestures without requiring changes to the mapping.

The technique can also capture the gestures of at least one additional human being playing at least one additional electronic instrument. As above, each gesture captured made by each additional human being is mapped to a standard MIDI control signal for operating each additional electronic instrument. The mapped MIDI control signals are then used to control each of the additional MIDI-capable electronic instruments.

FIG. 3 depicts a flow diagram for another computer-implemented process for using free-space gesture recognition to control a MIDI-capable electronic musical instrument. In this embodiment, free-space gestures of more than one human simulating playing an electronic musical instrument are captured, as shown in block 302. Each free-space gesture of each human being captured is mapped to a standard MIDI control signal for a standard MIDI-capable musical instrument, as shown in block 304. As discussed previously, in one embodiment of the technique the mapping of each gesture to a standard MIDI control signal is fixed. In an alternate embodiment, the mapping of each gesture to a standard MIDI control signal is editable by a user to allocate certain gestures to certain control signal meanings.

The mapped MIDI control signals are then used to play the one or more standard MIDI-capable musical instruments, as shown in block 306.

In one embodiment of the technique, each of the one or more human beings playing an electronic musical instrument using the captured gestures are located in a different location and the audio of at least one human being playing an electronic musical instrument at a first location is transmitted to the location of at least one other human being playing an electronic musical instrument over a network. In addition, video of one human being playing an electronic musical instrument at the first location can be sent to the location of at least one other human being playing an electronic musical instrument over a network.

2.0 The Computing Environment

The free-space gesture MIDI controller technique is designed to operate in a computing environment. The following description is intended to provide a brief, general description of a suitable computing environment in which the free-space gesture MIDI controller technique can be implemented. The technique is operational with numerous general purpose or special purpose computing system environments or configurations. Examples of well-known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 4 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 4, an exemplary system for implementing the free-space gesture MIDI controller technique includes a computing device, such as computing device 400. In its most basic configuration, computing device 400 typically includes at least one processing unit 402 and memory 404. Depending on the exact configuration and type of computing device, memory 404 may be volatile (such as RAM), non-volatile (such as ROM, flash memory, etc.) or some combination of the two. This most basic configuration is illustrated in FIG. 4 by dashed line 406. Additionally, device 400 may also have additional features/functionality. For example, device 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer readable instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Computer readable media include both transitory, propagating signals and computer (readable) storage media. Any such computer storage media may be part of device 400.

Device 400 also can contain communications connection(s) 412 that allow the device to communicate with other devices and networks. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 400 may have various input device(s) 414 such as a display, keyboard, mouse, pen, camera, touch input device, and so on. Output device(s) 416 devices such as a display, speakers, a printer, and so on may also be included. All of these devices are well known in the art and need not be discussed at length here.

The free-space gesture MIDI controller technique may be described in the general context of computer-executable instructions, such as program modules, being executed by a computing device. Generally, program modules include routines, programs, objects, components, data structures, and so on, that perform particular tasks or implement particular abstract data types. The free-space gesture MIDI controller technique may be practiced in distributed computing environments where tasks are performed by remote processing devices that are linked through a communications network. In a distributed computing environment, program modules may be located in both local and remote computer storage media including memory storage devices. Still further, the aforementioned instructions could be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for using free-space gesture recognition to control a MIDI-capable electronic device, comprising:
capturing free-space gestures of a first human being simulating playing a musical device;
mapping each gesture captured to a standard MIDI control signal for operating the musical device;
using the mapped MIDI control signals to control a MIDI-capable musical device.

2. The computer-implemented process of claim 1 wherein the mapping further comprises:
mapping each gesture captured to a standard MIDI control signal using a game console.

3. The computer-implemented process of claim 1 wherein the mapping further comprises:
mapping each gesture captured to a standard MIDI control signal using a computing device.

4. The computer-implemented process of claim 1 wherein the gestures are captured using a depth camera.

5. The computer-implemented process of claim 1, further comprising capturing audio of the user, or vocal or audio from another instrument, and any additional human beings present.

6. The computer-implemented process of claim 5 wherein the audio is captured by a microphone array that can also perform sound source localization.

7. The computer-implemented process of claim 1 wherein the MIDI-capable electronic device that can be controlled using the mapped MIDI control signals is a musical instrument.

8. The computer-implemented process of claim 1, further comprising:
capturing gestures of at least one additional human being playing at least one additional electronic device;
mapping each gesture captured by the at least one additional human being to a standard MIDI control signal for operating each of the at least one additional electronic device;
using the mapped MIDI control signals to control each of the at least one additional MIDI-capable electronic device.

9. The computer-implemented process of claim 1 wherein at least one of the additional human beings are at a different location of the first human being.

10. The computer-implemented process of claim 1 wherein any MIDI-capable electronic device can be controlled with the mapped gestures.

11. The computer-implemented process of claim 1 wherein the mapping of each gesture to a standard MIDI control signal is fixed to a certain control signal meaning.

12. The computer-implemented process of claim 1 wherein the mapping of each gesture to a standard MIDI control signal is editable by a user to allocate certain gestures to certain control signal meanings.

13. A computer-implemented process for using free-space gesture recognition to control a MIDI-capable electronic musical instrument, comprising:
capturing free-space gestures of more than one human simulating playing an electronic musical instrument;
mapping each free-space gesture of each human being captured to a standard MIDI control signal for a standard MIDI-capable musical instrument;
using the mapped MIDI control signals to play the one or more standard MIDI-capable musical instruments.

14. The computer-implemented process of claim 13 wherein the mapping of each free-space gesture to a standard MIDI control signal is fixed.

15. The computer-implemented process of claim 13 wherein the mapping of each gesture to a standard MIDI control signal is editable by a user to allocate certain gestures to certain control signal meanings.

16. The computer-implemented process of claim 13, further comprising
each of the one or more human beings playing an electronic musical instrument using the captured gestures in a different location; and
sending audio of one human being playing an electronic musical instrument at a first location to the location of at least one other human being playing an electronic musical instrument over a network.

17. The computer-implemented process of claim 16, further comprising
sending video of one or more human beings playing an electronic musical instrument at the first location to the location of at least one other human being playing an electronic musical instrument over a network.

18. A system for playing a musical device using gestures, comprising:
a general purpose computing device;
a computer program comprising program modules executable by the general purpose computing device, wherein the computing device is directed by the program modules of the computer program to,
capture gestures of a human being simulating playing an electronic musical device using a depth camera, wherein the module to capture gestures further comprises sub-modules to:
transmit encoded information on infrared light patterns in a space where the human being is gesturing; and
capture changes to the encoded infrared light patterns with the depth camera to determine which gestures the human being is making.
map each gesture captured to a standard control signal for operating an electronic musical device;
use the mapped control signals to play an electronic musical device.

19. The system of claim 18, wherein the module to map each gesture captured to a standard control signal for operating the musical device further comprising modules to:
prompt a human being to make a gesture representing a musical note or sequence;
record a gesture made by the prompted human being; and
map the recorded gesture to the musical note or sequence.

20. The system of claim 18, wherein each standard control signal is a MIDI control signal.
